(19) United States
(12) Patent Application Publication
(10) Pub. No.: US 2013/0329114 A1
(43) Pub. Date: Dec. 12, 2013

(54) IMAGE MAGNIFIER FOR PIN-POINT CONTROL

(71) Applicant: SAMSUNG ELECTRONICS CO., LTD., Suwon (KR)

(72) Inventors: Byoungju Kim, Walnut Creek, CA (US); Prashant Desai, San Francisco, CA (US); Jesse Alvarez, Oakland, CA (US)

(21) Appl. No.: 13/913,053

(22) Filed: Jun. 7, 2013

Related U.S. Application Data
(60) Provisional application No. 61/780,718, filed on Mar. 13, 2013.
(60) Provisional application No. 61/657,605, filed on Jun. 8, 2012.

(51) Int. Cl. H04N 5/262

(52) U.S. Cl. CPC H04N 5/2628
USPC 348/333.12

(57) ABSTRACT

A method for image control using magnification comprises selecting, using an electronic device, a portion of an image frame. The selected portion of the image frame is magnified. An action is performed on the magnified selected portion of the image frame for changing a feature of the selected portion of the image frame.

### CROSS-REFERENCE TO RELATED APPLICATIONS

This application claims the priority benefit of U.S. Provisional Patent Application Ser. No. 61/657,605, filed Jun. 8, 2012, and U.S. Provisional Patent Application Ser. No. 61/780,718, filed Mar. 13, 2013, both incorporated herein by reference in their entirety.

### TECHNICAL FIELD

One or more embodiments relate generally to image control using magnification and, in particular, to using image magnification for changing a feature of an image frame.

### BACKGROUND

With the rapid proliferation of mobile communication devices such as smartphones amongst users such as teenagers and children, there is an increase in use of integrated cameras via such devices.

### SUMMARY

In one embodiment, a method provides image control using magnification. One embodiment comprises a method that comprises selecting, using an electronic device, a portion of an image frame. In one embodiment, the selected portion of the image frame is magnified. In one embodiment, an action is performed on the magnified selected portion of the image frame for changing a feature of the selected portion of the image frame.

One embodiment provides a system for image control using magnification. In one embodiment, the system comprises an electronic device. In one embodiment, a camera module is used for displaying an image frame on a display. In one embodiment, a magnification module magnifies a selected portion of the image frame. In one embodiment, the camera module performs an action on the magnified selected portion of the image frame for changing a feature of the selected portion of the image frame.

Another embodiment provides a non-transitory computer-readable medium having instructions which when executed on a computer perform provides a method comprising selecting, using an electronic device, a portion of an image frame. In one embodiment, the selected portion of the image frame is magnified. In one embodiment, an action is performed on the magnified selected portion of the image frame for changing a feature of the selected portion of the image frame.

One embodiment provides a graphical user interface (GUI) displayed on a display of an electronic device. In one embodiment, the GUI comprises: a magnified portion of an image frame and an indicator of a change to the magnified portion shown within the magnified portion of the image display.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system for image control using magnification for an electronic device, according to an embodiment.

FIG. 3 shows an example scenario of image control using magnification for an electronic device, according to an embodiment.

FIGS. 4A-C show another example scenario for image control using magnification for an electronic device, according to an embodiment.

FIG. 5 shows a block diagram of a flowchart for image control using magnification for an electronic device, according to an embodiment.

FIG. 6 shows a computing environment for implementing an embodiment.

FIG. 7 shows a computing environment for implementing an embodiment.

FIG. 8 shows a computing environment for image magnification for changing a feature of an image frame, according to an embodiment.

FIG. 9 shows a block diagram of an architecture for a local endpoint host, according to an example embodiment.

FIG. 10 is a high-level block diagram showing an information processing system comprising a computing system implementing one or more embodiments.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to image control using magnification for an electronic device. In one embodiment, the electronic device comprises a mobile electronic device capable of data communication over a communication link such as a wireless communication link. Examples of such mobile device include a mobile phone device, a mobile tablet device, etc.

In one embodiment, a method provides image control using magnification for an electronic device. One embodiment comprises a method that comprises selecting a portion of an image frame on an electronic device. In one embodiment, the selected portion of the image frame is magnified. In one embodiment, an action is performed on the magnified selected portion of the image frame for changing a feature of the selected portion of the image frame.

One or more embodiments enable a user to activate a magnified view on a display for an image frame (e.g., a lie image or in editing mode) and use the magnified portion of the image to change a feature. In one embodiment, changing the feature comprises changing the focus point of an image using precise selection within the magnified portion of the image frame. In another embodiment, changing the feature comprises using the magnified portion to precisely select an area within the magnified portion for editing, such as cropping the area, changing contrast of the area, changing color of the area, and replacing the area with another image, etc.

In one embodiment, a user may activate the image control using magnification features by pressing a touch-screen display (e.g., a long press for selection, etc.), giving a voice command, etc.

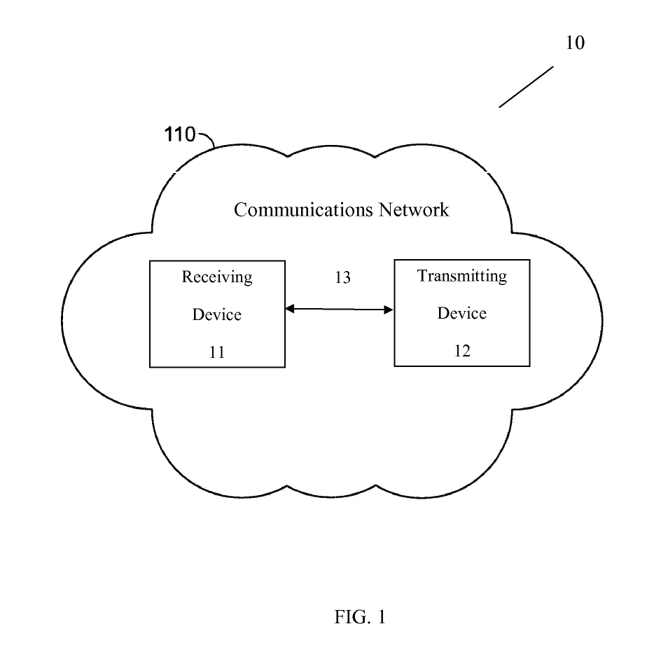

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a media player, a cellular telephone or a landline telephone, a personal e-mail or messaging device with audio and/or video capabilities, pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

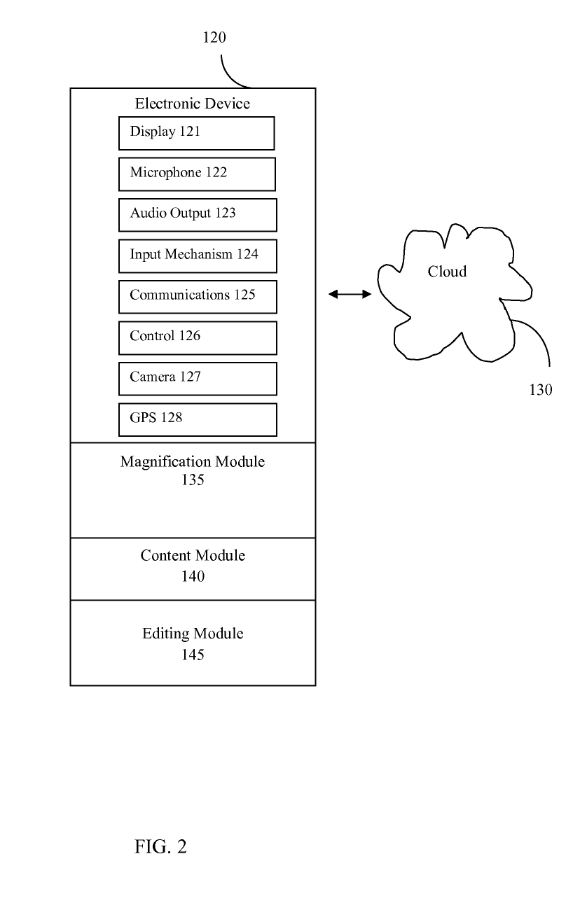

FIG. 2 shows a functional block diagram of an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, a camera 127, a global positioning system (GPS) receiver module 128, a magnification module 135, a content module 140 and an editing module 145, and any other suitable components. In one embodiment, content may be obtained or stored using the content module 140 or using the cloud or network 130, communications network 110, etc.

In one embodiment, all of the applications employed by audio output 123, display 121, input mechanism 124, communications circuitry 125 and microphone 122 may be interconnected and managed by control circuitry 126. In one example, a hand held music player capable of transmitting music to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen incorporated with the display 121. The input mechanism 124 may include a multi-touch screen. The input mechanism may include a user interface that may emulate a rotary phone or a multi-button keypad, which may be implemented on a touch screen or the combination of a click wheel or other user input device and a screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a camera application including a gallery application and an editing application, a calendar application, a contact list application, a map application, a media application (e.g., QuickTime, MobileMusic.app, or MobileVideo.app), etc. In some embodiments, the electronics device 120 may include one or several applications operative to perform communications operations. For example, the electronics device 120 may include a messaging application, a mail application, a telephone application, a voicemail application, an instant messaging application (e.g., for chatting), a videoconferencing application, a fax application, or any other suitable application for performing any suitable communications operation.

In some embodiments, the electronics device 120 may include microphone 122. For example, electronics device 120 may include microphone 122 to allow the user to transmit audio (e.g., voice audio) during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, or microphone 122 may be incorporated in a wireless headset.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, a user may direct electronics device 120 to perform a communications operation using any suitable approach. As one example, a user may receive a communications request from another device (e.g., an incoming telephone call, an email or text message, an instant message), and may initiate a communications operation by accepting the communications request. As another example, the user may initiate a communications operation by identifying another communications device and transmitting a request to initiate a communications operation (e.g., dialing a telephone number, sending an email, typing a text message, or selecting a chat screen name and sending a chat request).

In one embodiment, the GPS receiver module 128 may be used to identify a current location of the mobile device (i.e., user). In one embodiment, a compass module is used to identify direction of the mobile device, and an accelerometer and gyroscope module is used to identify tilt of the mobile device. In other embodiments, the electronic device may comprise a stationary electronic device, such as a television or television component system.

In one embodiment, the magnification module 135 provides interoperability with the camera module 127 for magnifying a portion of an image frame (e.g., a live image frame in camera mode and a previously captured image in editing mode). In one embodiment, the magnification acts as a magnifying glass by encircling a portion of the image frame and magnifying the selected portion for detailed viewing. In one embodiment, the magnification module 135 may be invoked via a long press on a touch-screen of the display 121 at the point that a user desires to magnify. In one embodiment, while using the camera module 127 for displaying a live-image prior to capture, the magnification module 135 may be used to change the focus point of the camera. In one embodiment, the focus point may comprise a default focus point that is centered on the image frame. In one embodiment, using the magnification module 135, a user may select a pin-point location on the image frame to magnify, and then may choose to use that pin-point as the focus point for capturing an image.

In one embodiment, the magnification module 135 may be invoked via a long press on a touch-screen of the display 121 at the point that a user desires to edit in editing mode. In one embodiment, while using the camera module 127 for displaying a captured photo, the magnification module 135 may be used to select a portion of the image frame to edit. In one embodiment, using the magnification module 135, a user may select a location on the image frame to magnify, and then may use the enlarged portion choose an area to select for editing. In one embodiment, only the area selected within the magnified portion is selected for editing, while the remaining portions of the image are not edited. In one embodiment, an element, such as a cross-hair may be used within the magnified portion to surround or lasso an area for editing that specific portion. In one embodiment, the magnified portion allows a user to see details of the un-magnified image in order to precisely select editing of a particular area with pin-point accuracy, while the remaining portion of the magnified portion is not edited. In one embodiment, features of the selected area may be changed via editing instead of editing a larger area. In one embodiment, the selected area for editing is outlined in order to provide feedback to the user.

In one embodiment, the content module 140 provides organized storing of images on the electronic device or obtained from the cloud 130. In one embodiment, the content module provides one or more galleries comprising images and albums of images, which may be edited using the editing module 145 in connection with the camera module 127.

In one embodiment, the editing module 145 provides editing functionality for the camera module 127. In one embodiment, the editing module allows features of images to be changed, such as cropping the area, changing contrast of the area, changing color of the area, and replacing the area with another image (e.g., replacing an image of a person's head with that of another's, replacing a background, etc.).

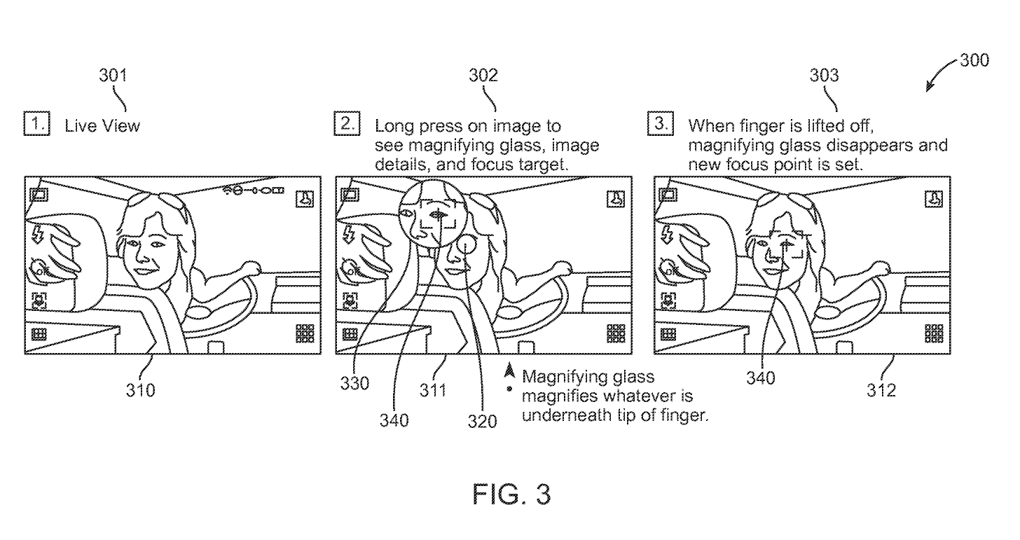

FIG. 3 shows an example scenario 300 of image control using magnification for an electronic device 120, according to an embodiment. In one embodiment, an image frame 310 shows a live-view of an image using the camera module 127. In one embodiment, the default focus point of the image frame 310 may be the center of the person's face or the center of the image frame. In one embodiment, the user desires to change the feature of the focus point.

In one embodiment, the user provides a long press 302 to a touch-screen of a display 121 over a portion of the image 320 desired to be the new focus point. The magnification module 135 provides a magnified view 330 of the surrounding portion selected by the user with the selected portion of the image 320 in the image frame 311. In one embodiment, in the live-view mode, the focus element 340 is then shown at the proposed focus point of the image. In one embodiment, the user may move their finger around the image frame in order to stop at the exact pin-point location for a desired new focus point. In one embodiment, when the user releases their finger from the touch-screen of the display 121, the magnified portion 330 disappears and the new focus point is set at the desired portion 340 of the image frame 312.

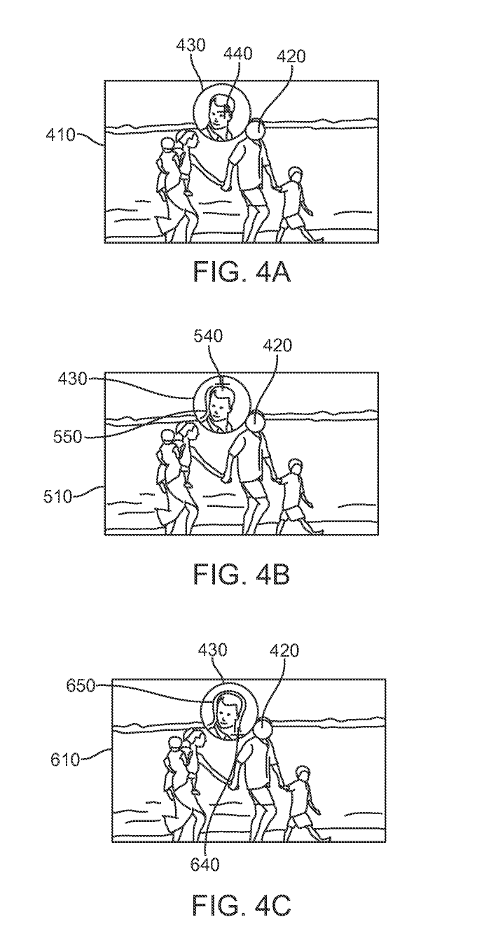

FIG. 4A-C show another example scenario for image control using magnification for an electronic device 120, according to an embodiment. In one embodiment, the user desires to use the editing module 145 to edit an image that may be obtained from the content module 140 (e.g., from a gallery, an album, etc.) or from the camera module 127 as a captured image. In FIG. 4A, the image frame 410 is shown in an editing mode. In one embodiment, the user desires to edit a portion of the image frame 410. In one embodiment, the user long presses on a touch-screen of the display 121 over a portion of the image 420 desired to be edited.

In one embodiment, the magnification module 135 provides the magnified portion 430 that includes a cross-hair element 440 within the magnified portion 430 in response to the long press over the portion 420. In one embodiment, the magnified portion 430 shows details of a person's head and the surrounding portion within the magnified portion 430.

FIG. 4B shows the image frame 510 where the user has dragged the cross-hair 540 from the left-side of the person's collar to the top of the person's head in the image within the magnified portion 430, according to one embodiment. In one embodiment, an outline 550 of the dragging of the cross-hair 540 is shown along the perimeter of the person's head.

FIG. 4C shows the cross-hair 640 dragged from the top of the person's head within the magnified portion 430 to the right-side of the person's collar in the image frame 610, according to one embodiment. In one embodiment, the portion of the image frame desired to be edited is highlighted or outlined as outline 650. In one embodiment, the dragging of the cross-hair 640 lassos the area desired to be edited with pin-point accuracy. In one embodiment, the editing module 145 snaps the outline to the portion of the image desired to be edited. In one embodiment, when the user let's go (i.e., stops pressing the touch-screen of the display 120), the magnified portion 430 disappears and the user may select the desired editing features for the selected (e.g., outlined) portion of the image frame.

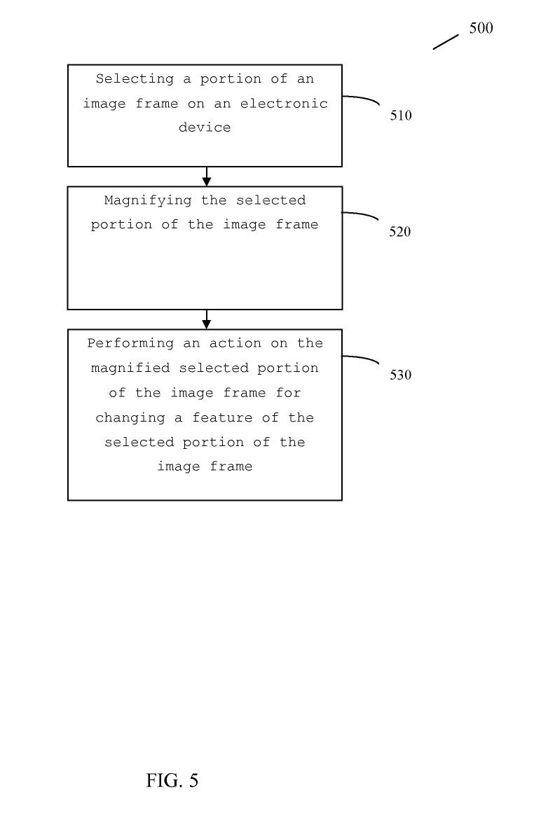

FIG. 5 shows a block diagram of a flowchart 500 for image control using magnification for an electronic device (e.g., electronic device 120), according to an embodiment. In one embodiment, in block 510 a portion of an image frame (e.g., a live image frame of an image shown using a camera module 127, an image previously captured shown in editing mode, etc.) is selected (e.g., from a long press using a touch-screen of a display 121) on the electronic device. In one embodiment, in block 520 the selected portion of the image frame is magnified (e.g., showing a magnified portion of the selected portion of the image frame).

In one embodiment, in block 530 an action is performed on the selected portion of the image frame for changing a feature of the image frame. In one embodiment, the action may comprise changing the focus point of the image frame in live mode, editing an area of the magnified portion in editing mode, etc.

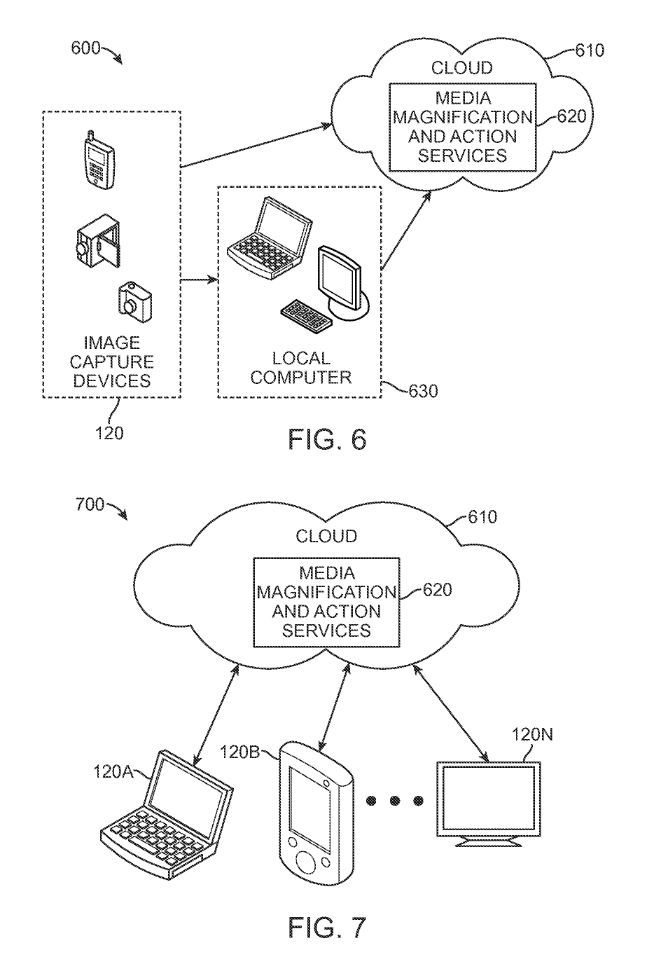

FIGS. 6 and 7 illustrate examples of networking environments 600 and 700 for cloud computing in which image magnification for changing a feature of an image frame embodiments described herein may utilize. In one embodiment, in the environment 600, the cloud 610 provides services 620 (such as image magnification for changing a feature of an image frame, social networking services, among other examples) for user computing devices, such as electronic device 120. In one embodiment, services may be provided in the cloud 610 through cloud computing service providers, or through other providers of online services. In one example embodiment, the cloud-based services 620 may include media processing and sharing services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, image magnification for changing a feature of an image frame (e.g., editing), etc. In one embodiment, the electronic devices 120 may upload one or more digital images to the service 620 on the cloud 610 either directly (e.g., using a data transmission service of a telecommunications network) or by first transferring the one or more images to a local computer 630, such as a personal computer, mobile device, wearable device, or other network computing device.

In one embodiment, as shown in environment 700 in FIG. 7, cloud 610 may also be used to provide services that include image magnification for changing a feature of an image frame embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 600 and 700, any of the embodiments may be implemented at least in part by cloud 610. In one embodiment example, image magnification for changing a feature of an image frame techniques are implemented in software on the local computer 630, one of the electronic devices 120, and/or electronic devices 120A-N. In another example embodiment, the image magnification for changing a feature of an image frame techniques are implemented in the cloud and applied to comments and media as they are uploaded to and stored in the cloud. In this scenario, the image magnification for changing a feature of an image frame embodiments may be performed using media stored in the cloud as well.

In one or more embodiments, media is shared across one or more social platforms from an electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add metadata or their own thoughts and feelings about the media using paradigms like comments, “likes,” and tags of people. Traditionally, this type of supplemental social data is made via separate social media platforms or applications (e.g., apps).

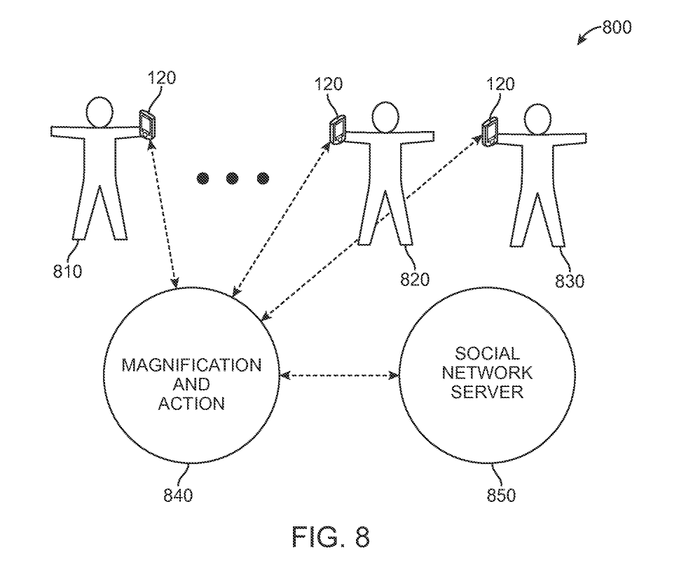

FIG. 8 is a block diagram 800 illustrating example users of an image magnification for changing a feature of an image frame system according to an embodiment. In one embodiment, users 810, 820, 830 are shown, each having a respective electronic device 120 that is capable of capturing and editing digital media (e.g., images, video, audio, or other such media) and providing image magnification for changing a feature of an image frame. In one embodiment, the electronic devices 120 are configured to communicate with a magnification and action controller 840, which is may be a remotely-located server, but may also be a controller implemented locally by one of the electronic devices 120. In one embodiment where the magnification and action controller 840 is a remotely-located server, the server may be accessed using the wireless modem, communication network associated with the electronic device 120, etc. In one embodiment, the magnification and action controller 840 is configured for two-way communication with the electronic devices 120. In one embodiment, the magnification and action controller 820 is configured to communicate with and access data from one or more social network servers 850 (e.g., over a public network, such as the Internet).

In one embodiment, the social network servers 850 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the magnification and action controller 840 may provide login and password information through an appropriate settings screen. In one embodiment, this information may then be stored by the magnification and action controller 840. In one embodiment, a user's private or public social network information may be searched and accessed by communicating with the social network server 850, using an application programming interface (“API”) provided by the social network operator.

In one embodiment, the magnification and action controller 840 performs operations associated with a magnification and action application or method. In one example embodiment, the magnification and action controller 840 may receive media from a plurality of users (or just from the local user), determine relationships between two or more of the users (e.g., according to user-selected criteria), and transmit comments and/or media to one or more users based on the determined relationships.

In one embodiment, the magnification and action controller 840 need not be implemented by a remote server, as any one or more of the operations performed by the magnification and action controller 840 may be performed locally by any of the electronic devices 120, or in another distributed computing environment (e.g., a cloud computing environment). In one embodiment, the sharing of media may be performed locally at the electronic device 120.

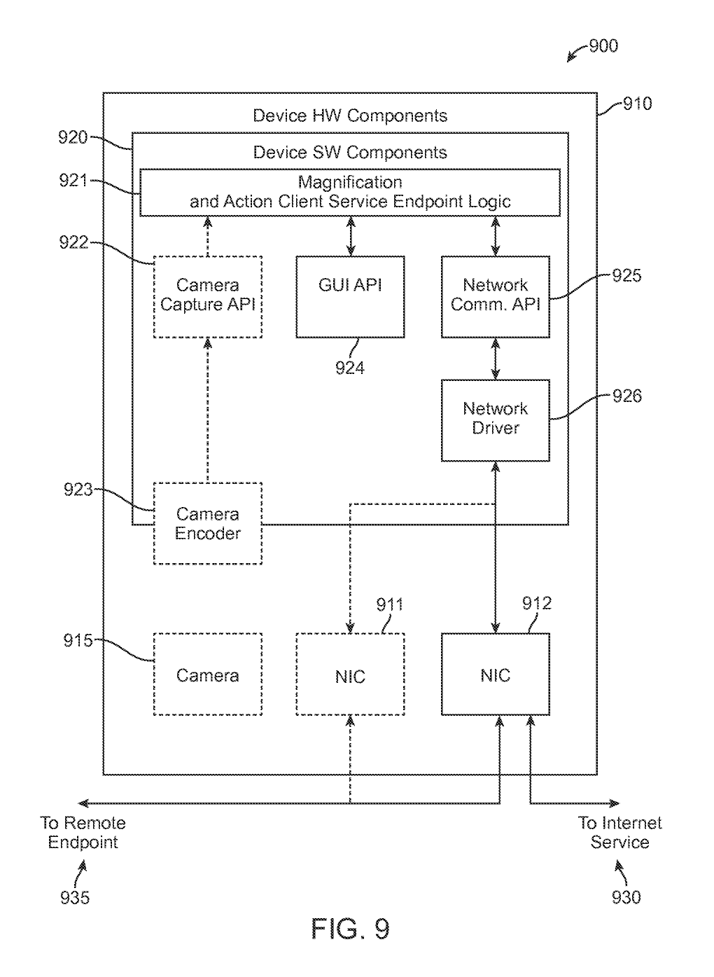

FIG. 9 shows an architecture for a local endpoint host 900, according to an embodiment. In one embodiment, the local endpoint host 900 comprises a hardware (HW) portion 910 and a software (SW) portion 920. In one embodiment, the HW portion 910 comprises the camera 915, network interface (NIC) 911 (optional) and NIC 912 and a portion of the camera encoder 923 (optional). In one embodiment, the SW portion 920 comprises magnification and action client service endpoint logic 921, camera capture API 922 (optional), a graphical user interface (GUI) API 924, network communication API 925, and network driver 926. In one embodiment, the content flow (e.g., text, graphics, photo, video and/or audio content, and/or reference content (e.g., a link)) flows to the remote endpoint in the direction of the flow 935, and communication of external links, graphic, photo, text, video and/or audio sources, etc. flow to a network service (e.g., Internet service) in the direction of flow 930.

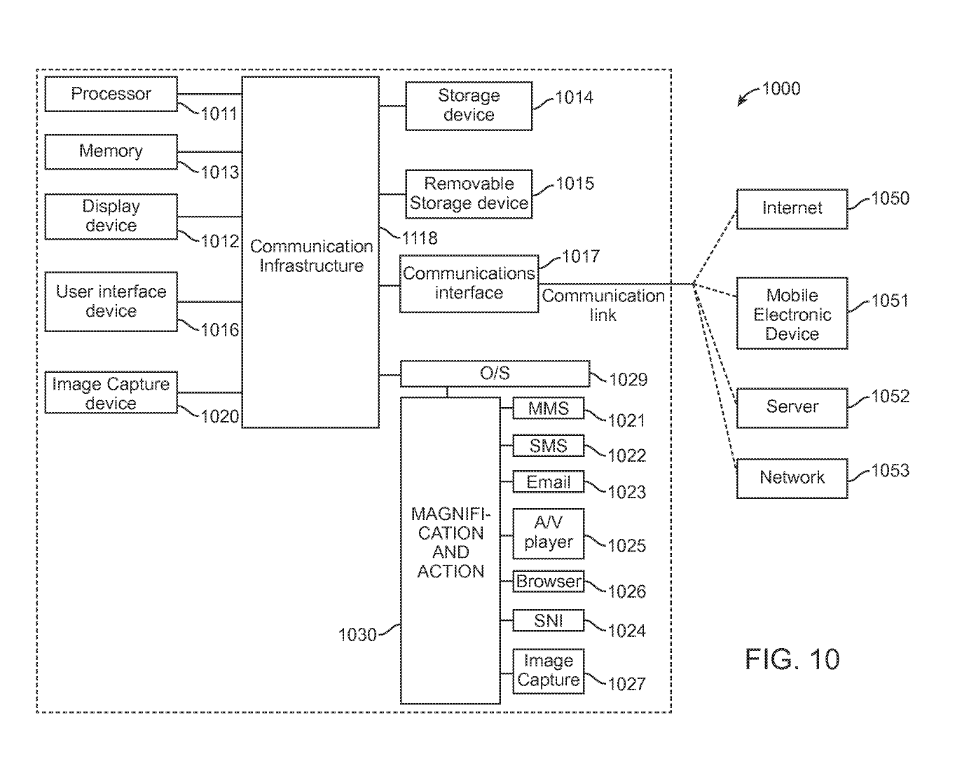

FIG. 10 is a high-level block diagram showing an information processing system comprising a computing system 1000 implementing an embodiment. The system 1000 includes one or more processors 1011 (e.g., ASIC, CPU, etc.), and can further include an electronic display device 1012 (for displaying graphics, text, and other data), a main memory 1013 (e.g., random access memory (RAM)), storage device 1014 (e.g., hard disk drive), removable storage device 1015 (e.g., removable storage drive, removable memory module, a magnetic tape drive, optical disk drive, computer-readable medium having stored therein computer software and/or data), user interface device 1016 (e.g., keyboard, touch screen, keypad, pointing device), and a communication interface 1017 (e.g., modem, wireless transceiver (such as WiFi, Cellular), a network interface (such as an Ethernet card), a communications port, or a PCMCIA slot and card). The communication interface 1017 allows software and data to be transferred between the computer system and external devices. The system 1000 further includes a communications infrastructure 1018 (e.g., a communications bus, cross-over bar, or network) to which the aforementioned devices/modules 1011 through 1017 are connected.

The information transferred via communications interface 1017 may be in the form of signals such as electronic, electromagnetic, optical, or other signals capable of being received by communications interface 1017, via a communication link that carries signals and may be implemented using wire or cable, fiber optics, a phone line, a cellular phone link, an radio frequency (RF) link, and/or other communication channels.

In one implementation of an embodiment in a mobile wireless device such as a mobile phone, the system 1000 further includes an image capture device such as a camera 127. The system 1000 may further include application modules as MMS module 1021, SMS module 1022, email module 1023, social network interface (SNI) module 1024, audio/video (AV) player 1025, web browser 1026, image capture module 1027, etc.

The system 1000 further includes a magnification and action module 1030 as described herein, according to an embodiment. In one implementation of said magnification and action module 1030 along an operating system 1029 may be implemented as executable code residing in a memory of the system 1000. In another embodiment, such modules are in firmware, etc.

One or more embodiments use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's on message callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for image control using magnification, comprising:
selecting, using an electronic device, a portion of an image frame;
magnifying the selected portion of the image frame; and
performing an action on the magnified selected portion of the image frame for changing a feature of the selected portion of the image frame.

2. The method of claim 1, wherein the image frame is a live image frame viewed on a display of the electronic device.

3. The method of claim 2, wherein the image frame comprises an image focus point, and the action comprises changing the image focus point to the selected portion of the image frame.

4. The method of claim 3, wherein a long press on the display over the selected portion magnifies the selected portion and upon removing the long press changes the feature comprising changing the image focus point to the selected portion.

5. The method of claim 1, wherein the image frame is viewed in an edit mode on a display of the electronic device.

6. The method of claim 5, wherein the action comprises changing the feature comprising editing the selected portion of the image frame.

7. The method of claim 6, wherein the editing only changes the selected portion of the image frame.

8. The method of claim 7, wherein a long press on the display over the selected portion magnifies the selected portion, and a dragging of a cross-hair element on the display within the magnified selected portion surrounds an area of the selected portion for editing only the surrounded area within the selected portion.

9. The method of claim 5, wherein editing comprises one or more of enhancing the area, cropping the area, changing contrast of the area, changing color of the area, and replacing the area with another image.

10. The method of claim 1, wherein the electronic device comprises a mobile phone.

11. A system for image control using magnification, comprising:
an electronic device;
a camera module used for displaying an image frame on a display; and
a magnification module for magnifying a selected portion of the image frame,
wherein the camera module performs an action on the magnified selected portion of the image frame for changing a feature of the selected portion of the image frame.

12. The system of claim 11, wherein the image frame is a live image frame viewed on the display of the electronic device.

13. The system of claim 12, wherein the image frame comprises an image focus point, and the action comprises the camera module changing the feature comprising changing the image focus point to the selected portion of the image frame.

14. The system of claim 13, wherein a long press on the display over the selected portion causes the magnifying module to magnify the selected portion, and upon removing the long press the camera module changes the image focus point to the selected portion.

15. The system of claim 14, wherein the image frame is viewed in an edit mode on the display.

16. The system of claim 15, wherein the action comprises changing the feature comprising editing the selected portion of the image frame using an editing module.

17. The system of claim 16, wherein the editing only changes the selected portion of the image frame.

18. The system of claim 17, wherein a long press on the display over the selected portion magnifies the selected portion using the magnification module, and a dragging of a cross-hair element on the display within the magnified selected portion surrounds an area of the selected portion for the editing module to perform editing of only the surrounded area within the selected portion.

19. The system of claim 16, wherein editing comprises one or more of enhancing the area, cropping the area, changing contrast of the area, changing color of the area, and replacing the area with another image.

20. The system of claim 11, wherein the electronic device comprises a mobile phone.

21. A non-transitory computer-readable medium having instructions which when executed on a computer perform provides a method comprising:
selecting, using an electronic device, a portion of an image frame;
magnifying the selected portion of the image frame; and
performing an action on the magnified selected portion of the image frame for changing a feature of the selected portioned of the image frame.

22. The medium of claim 21, wherein the image frame is a live image frame viewed on a display of the electronic device, and the image frame comprises an image focus point, and the action comprises changing the feature comprising changing the image focus point to the selected portion of the image frame.

23. The medium of claim 22, wherein a long press on the display over the selected portion magnifies the selected portion and upon removing the long press changes the image focus point to the selected portion.

24. The medium of claim 21, wherein the image frame is viewed in an edit mode on a display of the electronic device, and the action comprises changing the feature comprising editing the selected portion of the image frame.

25. The medium of claim 24, wherein a long press on the display over the selected portion magnifies the selected portion, and a dragging of a cross-hair element on the display within the magnified selected portion surrounds an area of the selected portion for editing only the surrounded area within the selected portion.

26. The medium of claim 24, wherein editing comprises one or more of enhancing the area, cropping the area, changing contrast of the area, changing color of the area, and replacing the area with another image.

27. The medium of claim 21, wherein the electronic device comprises a mobile phone.

28. A graphical user interface (GUI) displayed on a display of an electronic device, comprising:
a magnified portion of an image frame; and
an indicator of a change to the magnified portion shown within the magnified portion of the image display.

29. The GUI of claim 28, wherein the indicator indicates a change to a new focus point in the image frame, wherein the image frame is a live view for capturing the image frame.

30. The GUI of claim 28, wherein the indicator indicates a selection of an area within the magnified portion that is selected for editing in an editing mode using the electronic device.
